(19) United States
(12) Patent Application Publication
(10) Pub. No.: US 2008/0082710 A1
(43) Pub. Date: Apr. 3, 2008

(54) System and method for managing system management interrupts in a multiprocessor computer system

(75) Inventors: Vijay Nijhawan, Austin, TX (US); Madhusudhan Rangarajan, Round Rock, TX (US); Bi-Chong Wang, Austin, TX (US); Wuxian Wu, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/540,804

(22) Filed: Sep. 29, 2006

(51) Int. Cl. G06F 13/24

(52) U.S. Cl. 710/260

(57) ABSTRACT

A system and method is disclosed in which, during the execution of an interrupt handling sequence in one of the processor of a multiprocessor system, a processors write a reason code to a status register to identify the cause of the interrupt. The BIOS code of the system writes to an interrupt initiation register to cause each of the processors to enter an interrupt handling sequence. Each of the processors of the system handling the interrupt on the basis of the content of the status register, resulting in each of the processors synchronously handling an interrupt for an event that would otherwise result in a local interrupt.

### TECHNICAL FIELD

The present disclosure relates generally to computer systems and information handling systems, and, more particularly, to a system and method for managing interrupts in a multiprocessor computer system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include multiple processors, with each processor being directly coupled to a unique set of memory resources. In this environment, each processor is able to handle interrupts generated by the computer system. As an example, if a single bit error occurs in memory, the processor that is directly coupled to the memory will handle the system management interrupt (SMI) associated with the single bit error. During the period that one of the processors of the computer system is processing the system management interrupt, the other processors of the computer system may continue to execute operating system instructions. If, during the handling of the system management interrupt, the processors contend for shared system resources, the computer system could become unstable and crash.

To reduce the possibility of contention for shared system resources during the processing of a SMI for a single bit error, the interrupt handling processor can generate a soft SMI upon exiting the interrupt handling routine that was associated with the original SMI for the single bit error. The issuance of the soft SMI causes all of the processors to handle the soft SMI, thereby causing all of the processors to recognize the single bit error. One difficulty with this approach is that, if a second SMI occurs during the period that the interrupt handling processor is processing the initial SMI, the existence of the second SMI will cause the soft SMI to be dropped and the single bit error will not be recognized by the other processors of the computer system.

### SUMMARY

In accordance with the present disclosure, a system and method is disclosed in which, during the execution of an interrupt handling sequence in one of the processor of a multiprocessor system, a processors write a reason code to a status register to identify the cause of the interrupt. The BIOS code of the system writes to an interrupt initiation register to cause each of the processors to enter an interrupt handling sequence. Each of the processors of the system handling the interrupt on the basis of the content of the status register, resulting in each of the processors synchronously handling an interrupt for an event that would otherwise result in a local interrupt.

The system and method disclosed herein is technically advantageous because it results in the generation of synchronous system management interrupts for events that would otherwise result in the generation of only a local system management interrupt. The synchronous handling of system management interrupts avoids the possibility of dropping or failing to address system management interrupts that occur during the period that another system management interrupt is pending. Because of the system and method disclosed herein, events that only generate local system management interrupts will be recognized by each processor of the system; rather than being dropped at other processors of the system in favor of a superseding interrupt event. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of the architecture of the computer system;

FIG. 2 is a flow diagram of a method steps for handling an interrupt within each processor of a multiprocessor system; and

FIG. 3 is a flow diagram of a method for executing a system control interrupt handler in the BIOS

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

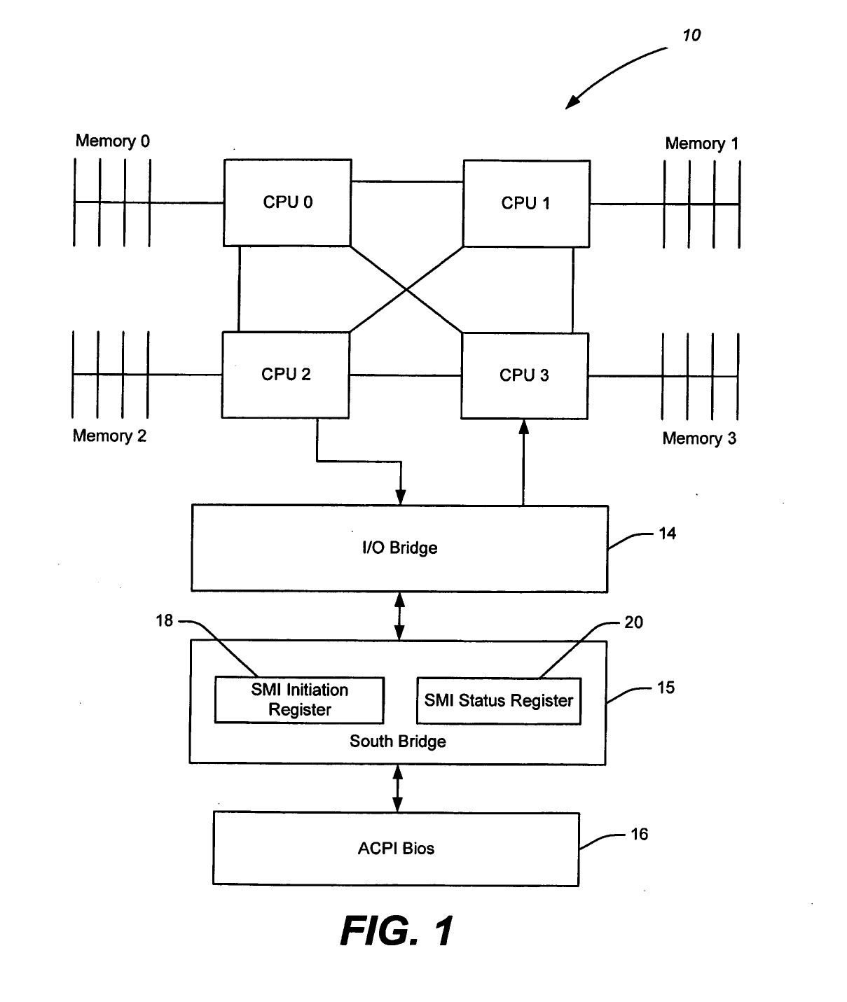

Shown in FIG. 1 is a diagram of the architecture of a computer system, which is indicated generally at 10. Computer system 10 is a multiprocessor system that includes four processors, which are identified is CPU 0, CPU 1, CPU 2, and CPU 3. Each processor is directly coupled to each of the other processors. In addition, each processor is directly coupled to an array of local memory that is uniquely associated with the processor. In the example of FIG. 1, CPU 0 is directly coupled to a memory array identified as Memory 0; CPU 1 is directly coupled to Memory 1; CPU 2 is directly coupled to Memory 2; and CPU 3 is directly coupled to Memory 3.

In the architecture of FIG. 1, one of the processors, which in this example is CPU 2, is coupled to a first I/O bridge 14, which is sometimes referred to as a north bridge. I/O bridge 14 is coupled to a second I/O bridge 15 or south bridge. A BIOS ROM 16 is coupled to south bridge 15. BIOS ROM 15 includes both standard BIOS software and, as indicated in FIG. 1, ACPI power management software. Included within south bridge 15 are a number of registers, which are identified in FIG. 1 as interrupt initiation register at 18 and SMI status register 20.

The system and method that is disclosed herein concerns a method for managing interrupts within a multiprocessor computer system. As an example, when the number of single bit errors within a single memory array reaches a threshold value, a system management interrupt is initiated. The processor that is designated to handle the system manage interrupt is the processor that is directly coupled to the memory array that includes the single bit errors. As an example, assume that a threshold number of single bit errors have occurred in Memory 1. A system management interrupt will be issued, and CPU 1 will handle the system management interrupt. In this description, the processor that is handling the interrupt will be referred to as the local processor, as this processor is local to or directly coupled to the local memory that is the source of the system management interrupt.

As part of the handling of the system management interrupt by the local processor, the local processor writes to the interrupt initiation register 18 of hub 14 to generate a system control interrupt. The local processor also writes a code to SMI status register 20. The code written to SMI status register 20 comprises a local SMI reason code, which represents the reason for or cause of the system management interrupt. The existence of a local SMI reason code in the SMI status register also serves as flag to indicate that the local processor will soon complete the handling of the system management interrupt.

As a result of the initiation of the system control interrupt, code within BIOS will periodically check the SMI status register 20 to determine if a local SMI reason code has been written to the SMI status register. If a local SMI reason code has not been written to the SMI status register, SMI status register 20 will have a zero or null value. The existence of a local SMI reason code acts as a semaphore that indicates whether the local processor will soon complete its interrupt handling sequence. When a non-zero value is finally found in SMI status register 20, the BIOS generates a soft system management interrupt for all processors by writing to the interrupt initiation register 18. Once a flag is written to interrupt initiation register 18, all of the processors of the system execute a system management interrupt, using the SMI local reason code of the SMI status register 20 to identify the action to be taken in response during the handling of the system management interrupt.

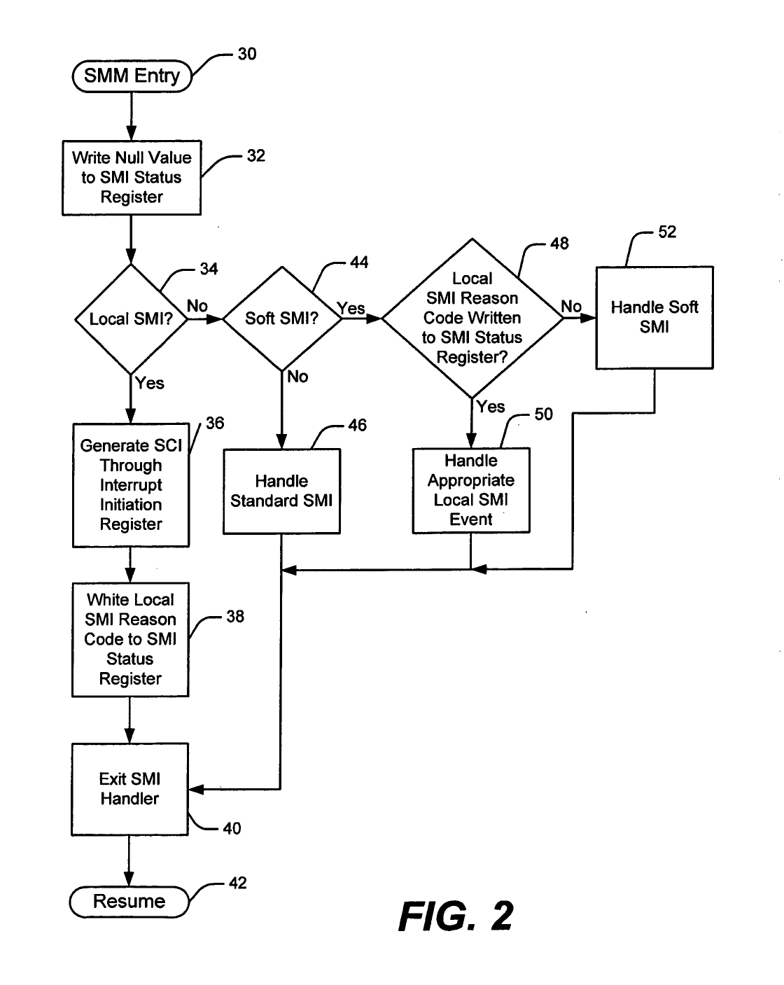

Shown in FIG. 2 is a flow diagram of a series of method steps for handling an interrupt within each processor of a multiprocessor system. At step 30, one of the processors of the system enters system management mode and begins processing a system management interrupt. At step 32, the processor writes a null value to the SMI status register. The processor determines at step 34 if the system management interrupt is a local system management interrupt. A local system management interrupt is an interrupt that was initially assigned to the processor. As an example, in the case of a single bit error in Memory 0, the system management interrupt would be handled by CPU 0, and, for CPU 0, the system management interrupt would be a local system management interrupt. For the other processors of the system, a subsequent system management interrupt that is initiated to log the single bit error of Memory 0 would not be a local system management interrupt.

If it is determined at step 34 that the system management interrupt is a local system management interrupt, the processor at step 36 generates a system control interrupt by writing to the interrupt initiation register 18. At step 38, the processor writes the local SMI reason code to the SMI status register 20, and, at step 40, the processor exits the handling of the system management interrupt. Following step 40, the processor resumes normal operation at step 42. If, however, it is determined at step 34 that the system management interrupt is not a local system management interrupt, it is next determined at step 44 if the system management interrupt is a soft system management interrupt. If the system management interrupt is not a soft system management interrupt, the standard system management interrupt is handled at step 46 and the processor exits the handling of the system management interrupt at step 40.

If it is determined at step 44 that the system management interrupt is a soft system management interrupt, it is next determined at step 48 if SMI status register 20 has a non-null value. If it is determined at step 48 if the SMI status register 20 has a null value, then it is known that, although the system management interrupt is a soft system management interrupt, the soft system management interrupt was not initiated following the existence of a standard interrupt in another processor of the computer system. In this case, the soft system management interrupt is handled at step 52 and the processor exits the handling of the system management interrupt at step 40. If it is determined at step 48 that a local SMI reason code has been written to the SMI status register, the processor, on the basis of the local SMI reason code, handles the system management interrupt event at step 50 and the processor exits the handling of the system management interrupt at step 40.

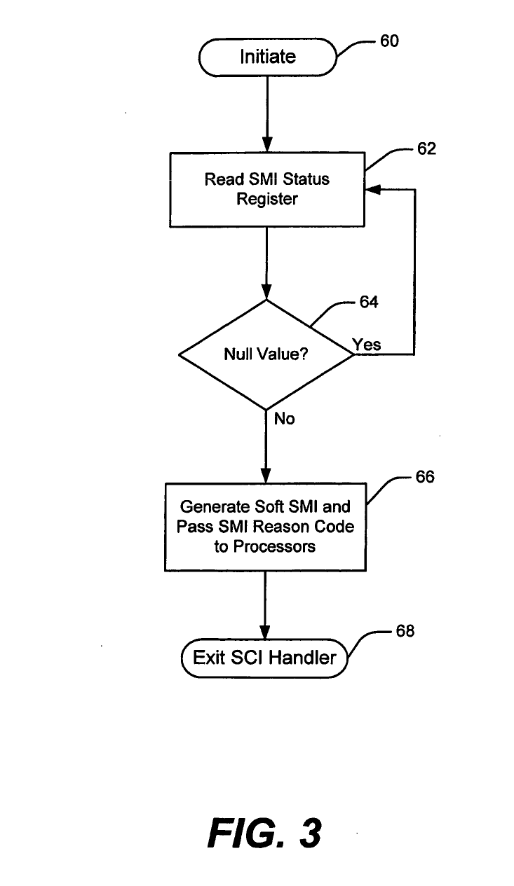

Shown in FIG. 3 is a flow diagram of a series of method steps executing a system control interrupt handler in the BIOS. At step 60, the system control interrupt handler of the BIOS is initiated. At step 62, the BIOS reads the SMI status register and determines at step 64 if the value of the SMI status register is a null value. If the value of the SMI status register is a null value, which indicates that the local processor that is handling the system management interrupt has not completed the processing of the system management interrupt, the flow diagram of FIG. 3 loops back to steps 62 and 64. If the value of the SMI status register is not a null value, which indicates that the local processor that is handling the system management interrupt has completed the processing of the system management interrupt, the system control interrupt handler at step 66 generates a soft system management interrupt for each of the other processors and passes the local SMI reason code to each of the processors of the computer system. At step 68, the system control interrupt handler of the BIOS terminates.

Although the system and method disclosed herein has been described with respect to a distributed memory configuration, it should be understood that the system and method described herein is not limited to the memory configuration shown in FIG. 1. Rather, then system and method described herein may be employed in any multiprocessor system to manage the contention among interrupts in a multiprocessor system. Although the present disclosure has been described in detail, it should be understood that various changes, substitutions, and alterations can be made hereto without departing from the spirit and the scope of the invention as defined by the appended claims.

What is claimed is:

1. A method for managing interrupts in a multiprocessor system, comprising:
executing an interrupt handling sequence at a first processor to handle an interrupt within the system;
writing a flag to a designated memory location;
initiating an interrupt handling sequence at each processor of the computer system, wherein each processor reads in the flag at the designated memory location as an input to the interrupt handling sequence at the processor.

2. The method for managing interrupts of a multiprocessor system of claim 1, wherein the flag identifies the cause of the interrupt.

3. The method for managing interrupts of a multiprocessor system of claim 1, wherein the step of writing a flag to the designated memory location comprises the step of writing a flag to a register of an I/O bridge in the system.

4. The method for managing interrupts of a multiprocessor system of claim 1, wherein the step of writing a flag to the designated memory location comprises the step of writing a flag to a register of a south bridge in the system.

5. The method for managing interrupts of a multiprocessor system of claim 1, wherein the step of initiating an interrupt handling sequence at each processor of the computer system comprises the step of writing to a register in an I/O bridge of the system to initiate an interrupt handling sequence at each processor of the system.

6. The method for managing interrupts of a multiprocessor system of claim 1, wherein the step of initiating an interrupt handling sequence at each processor of the computer system comprises the step of writing to a register in south bridge of the system to initiate an interrupt handling sequence at each processor of the system.

7. The method for managing interrupts of a multiprocessor system of claim 1, further comprising the step of executing an interrupt handling sequence at each processor of the system.

8. The method for managing interrupts of a multiprocessor system of claim 1, wherein the step of executing an interrupt handling sequence at each processor of the system comprises the steps of,
determining if the system management interrupt is a soft system management interrupt; and
if the system management interrupt is a soft system management interrupt, reading the designated memory location to determine whether to execute an interrupt handling sequence on the basis of the content of the designated memory location.

9. The method for managing interrupts of a multiprocessor system of claim 9, wherein the step of reading the designated memory location to determine whether to execute an interrupt handling sequence on the basis of the content of the designated memory location comprises the steps of,
if the designated memory location includes a non-null value, executing an interrupt handling sequence on the basis of the non-null value; and
if the designated memory location includes a null value, executing an interrupt handling sequence to process the soft system management interrupt.

10. The method for managing interrupts of a multiprocessor system of claim 9, wherein the designated memory location is within an I/O bridge of the system.

11. An information handling system, comprising:
a plurality of processors;
an interrupt initiation register;
an interrupt status register;
wherein, upon the initiation of an interrupting handling sequence at a first processor of the plurality of processors,
writing a flag to the interrupt status register to cause each of the plurality of processors to enter an interrupt handling sequence in which each processors reads the content of the interrupt status register as an input to the interrupt handling sequence executed at the processor.

12. The information handling system of claim 11, wherein, if the content of the interrupt status is a non-null value, executing an interrupt handling sequence that corresponds to the non-null value of the interrupt status register.

13. The information handling system of claim 11, wherein, if the content of the interrupt status is a null value, executing an interrupt handling sequence that corresponds to the handling of a soft system management interrupt.

14. The information handling system of claim 11, wherein the interrupt initiation register is within an I/O bridge of the system.

15. The information handling system of claim 11, wherein the interrupt initiation register is within a south bridge of the system.

16. The information handling system of claim 11, wherein the interrupt status register is within an I/O bridge of the system.

17. The information handling system of claim 11, wherein the interrupt status register is within a south bridge of the system.

18. A method for processing interrupts in a multiprocessor system, comprising:
at a first processor of the system, writing an interrupt reason code to an interrupt status register of the system;
writing to an interrupt status register to cause each of the processors of the system to enter an interrupt handling sequence;
executing an interrupt handling sequence at each of the processor of the system, wherein the operation of the interrupt handling sequence depends on the content of the interrupt status register.

19. The method for processing interrupts in a multiprocessor system of claim 18, wherein, if the content of the interrupt status register is a non-null value, the step of executing an interrupt handling sequence comprises the step of executing an interrupt handling sequence that corresponds to the non-null value of the interrupt status register.

20. The method for processing interrupts in a multiprocessor system of claim 18, wherein, if the content of the interrupt status register is a null value, the step of executing an interrupt handling sequence comprises the step of handling a soft system management interrupt.
